(19) United States
(12) Patent Application Publication
(10) Pub. No.: US 2008/0139382 A1
(43) Pub. Date: Jun. 12, 2008

(54) CATALYST FOR PURIFICATION OF EXHAUST GAS

(75) Inventors: Hideaki Morisaka, Yokohama-shi (JP); Hironori Wakamatsu, Yokohama-shi (JP); Masanori Nakamaura, Yokosuka-shi (JP); Kazuyuki Shiratori, Yokohama-shi (JP); Hirofumi Yasuda, Yokosuka-shi (JP); Katsuo Suga, Yokohama-shi (JP)

Correspondence Address: YOUNG & BASILE, P.C., 3001 WEST BIG BEAVER ROAD, SUITE 624, TROY, MI, 48084, US

(73) Assignee: NISSAN MOTOR CO., LTD., Yokohama-shi (JP)

(21) Appl. No.: 11/861,644

(22) Filed: Sep. 26, 2007

(30) Foreign Application Priority Data
Oct. 5, 2006 (JP) 2006-274462

(51) Int. Cl. B01J 23/10; B01J 23/38

(52) U.S. Cl. 502/302; 502/300; 502/303; 502/304; 502/337; 502/338; 502/325; 502/324; 502/343; 502/345; 502/339; 502/344; 502/347; 502/355

(57) ABSTRACT

A catalyst for purifying exhaust gas that provides a superior catalytic performance even at a high temperature by increasing the durability of the promoter. The catalyst for purifying exhaust gas includes a promoter clathrate wherein a promoter component particle is covered with a high heat-resistant oxide. A promoter active species is contained in the promoter clathrate. The catalytic active species are located adjacent to the promoter clathrates. The catalytic active species has a precious metallic particle having a catalyst activity, a metallic oxide particle for bearing the precious metallic particle and a metallic oxide placed around the metallic oxide particle and the precious metallic particle.

### CROSS-REFERENCE TO RELATED APPLICATION

This application claims priority from Japanese Patent Application Serial No. 2006-274462, filed Oct. 5, 2006, which is incorporated herein in its entirety by reference.

### TECHNICAL FIELD

The invention relates to a catalyst for purifying exhaust gas by efficiently removing carbon monoxide (CO), hydrocarbon (HC) and nitrogen oxide (NOₓ) contained in the exhaust gas of a vehicle.

### BACKGROUND

Precious metals such as platinum (Pt), rhodium (Rh), palladium (Pd), etc., have been widely used as a catalytic active component in a tertiary catalyst for simultaneously purifying exhaust gas by removing CO, HC and NOₓ from the gas. A commonly known catalyst for purifying exhaust gas utilizes precious metals supported on an oxide support such as alumina, zirconia and titania. Such a catalyst is applied to a surface of an inner wall of a honeycomb substrate made from cordierite to purify exhaust gas introduced into the honeycomb substrate.

A promoter is added to the catalyst to enhance catalytic performance. Such a promoter may be a transition metallic oxide. The promoter contacts or is adjacent to a particle of the precious metal (a catalytic active component) and functions to enhance catalyst activity.

Recently, the temperature of exhaust gas of a vehicle has been increasing due to high torque or speeds of a gasoline engine. The honeycomb substrate containing the catalyst is disposed directly under the engine to rapidly increase its temperature to that temperature where catalysis occurs. This placement provides for exhaust purification as soon as possible after engine start-up. Because of the increase in engine operation temperature, the catalyst is required to be used at a higher temperature range. This increased temperature decreases catalyst durability. Further, the grain growth generated in a precious metal due to high temperatures deteriorates the activity of the catalyst.

Japanese Patent Laid-Open Application Nos. (Hei.) 8-131830, 2005-000829, 2005-000830 and 2003-117393 disclose exhaust purification catalysts containing promoters disposed adjacent to the precious metallic particles to restrain the atmospheric transition around the precious metallic particles.

However, as with the catalytic-active component, the promoter particles will also cohere to each other in a high temperature setting, and grain growth is generated. This reduces the surface area of the promoter particle, thereby deteriorating the performance of the promoter. The grain growth of the promoter may deteriorate the durability of the catalytic active component as well.

### BRIEF SUMMARY

Taught herein are embodiments of a catalyst for purifying exhaust gas.

In one embodiment of an exhaust gas purification catalyst, the catalyst comprises a promoter clathrate having a promoter component particle covered with a high heat-resistant oxide. The catalyst according to this embodiment further comprises a catalytic active species adjacent to the promoter clathrate. The catalytic active species includes a first metallic oxide, catalytic active particles born on the first metallic oxide and a second metallic oxide. The second metallic oxide operates as a cage around the catalytic active particles and the first metallic oxide.

In another embodiment of the catalyst, the catalyst comprises a promoter clathrate wherein a promoter component particle is covered with a high heat-resistant oxide. The catalyst further comprises a catalytic active species adjacent to the promoter clathrate, and the catalytic active species comprises a composite oxide particle and a metal oxide. The composite oxide particle is at least one precious metal and at least one rare-earth element, and the metal oxide operates as a cage around the composite oxide particle.

### BRIEF DESCRIPTION OF THE DRAWINGS

The description herein makes reference to the accompanying drawings wherein like reference numerals refer to like parts throughout the several views, and wherein:

FIG. 1 is a schematic view of an example of a catalyst for purification of exhaust gas in accordance with an embodiment as disclosed herein; and

FIG. 2 is a schematic view of another example of a catalyst for purification of exhaust gas in accordance with an embodiment as disclosed herein.

### DETAILED DESCRIPTION OF EMBODIMENTS OF THE INVENTION

In order to reduce toxic emissions gases and to compensate for the deterioration in catalyst performance based on longer driving distances and higher driving speeds, excess amounts of precious metals are required. One main cause of deterioration in conventional emission catalysts is the reduction in the effective catalytic surface area, as well as reduction of the promoter active area. This reduction occurs when the precious metal particles or promoter particles migrate, unite and cause grain growths on the stable metal oxide surface when exposed to emissions at high temperatures. In contrast, embodiments of the invention disclosed herein prevent cohesion and grain growth of both the promoter and the precious metals.

Hereinafter, certain embodiments of the inventive catalyst are described with reference to the accompanying drawings.

The exhaust gas purification catalyst in the disclosed embodiments comprises a catalytic active species and a promoter clathrate adjacent to the catalytic active species. Any known catalytic active species may be employed as thee catalytic active species. An example of the catalyst having a proper catalytic active species is explained below.

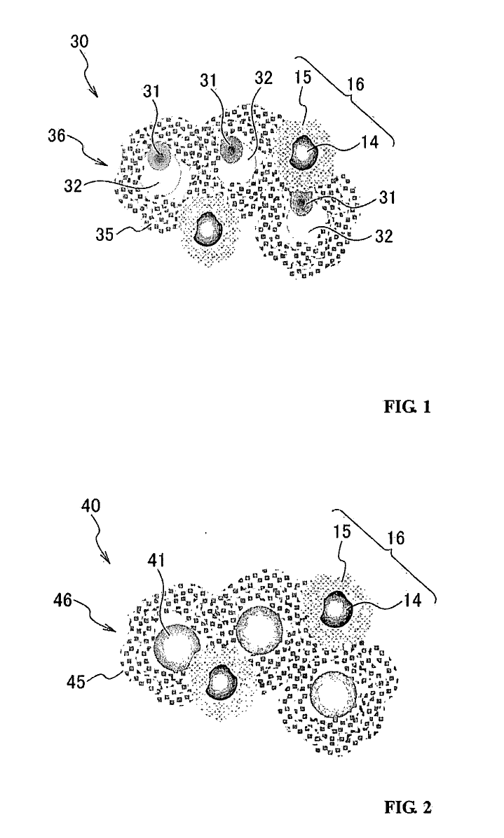

FIG. 1 shows an example of a catalyst for purifying exhaust gas in accordance with an embodiment of the invention. A catalyst 30 shown in FIG. 1 has the promoter clathrate 16 consisting of the promoter component particle 14 and the high heat-resistant oxide 15 covering the promoter component particle 14.

A catalytic active species 36 is located adjacent to the promoter clathrates 16, which include promoter component particles 14. The catalytic active species 36 has a precious metallic particle 31 having a catalyst activity, a metallic oxide particle 32 for bearing the precious metallic particle 31, and a metallic oxide 35 operating as a cage or lattice-like structure around the metallic oxide particle 32 and tile precious metallic particle 31.

In the catalyst 30, the precious metallic particle 31 is born by the metallic oxide particle 32, restraining particle movement by an anchor effect with the metallic oxide particle 32. In addition, the precious metallic particle 31 is caged within the metallic oxide 35. To this end, the particle movement of the precious metallic particle 31 is further restrained by the clathrate effect of the metallic oxide 35. Therefore, the precious metallic particles 31 are restrained from being moved and cohered with each other at a high temperature. This eliminates deterioration of the catalyst activity due to grail growth. Although the precious metallic particle 31 is caged within the metallic oxide 35, the metallic oxide 35 is a porous material having an air-permeability. The exhaust gas thus sufficiently reaches the precious metallic particles 31 for purification by the precious metallic particle 31. Therefore, the function of the precious metallic particles 31 is not damaged.

FIG. 2 shows another example of a catalyst for purifying exhaust gas. Similar to the catalyst 30 for purification of exhaust gas, a catalyst 40 shown in FIG. 2 has the promoter clathrate 16 consisting of the promoter component particle 14 and the high heat-resistant oxide 15 for covering the promoter component particle 14.

A catalytic active species 46 is located adjacent to the promoter clathrates 16, which include the promoter particles 14. The catalytic active species 46 has a composite oxide particle 41 having precious metals and rare-earth elements. It also has a metallic oxide 45 that cages the composite oxide particle 41. The catalytic active species 46 is comprised of the composite oxide particle 41 with the metallic oxide 45 operating as a cage or lattice-like structure around the composite oxide particle 41.

In the catalyst 40, the composite oxide particle 41, composed of the precious metals and rare-earth elements, has a heat resistance, thereby slowing decomposition of the precious metals. The heat resistance of the exhaust gas purification catalyst is improved, extending the life of the catalyst.

Because the composite oxide particle 41 is caged within the metallic oxide 45, the particle movement of the composite oxide particle 41 is restrained by the clathrate effect of the metallic oxide 45. Therefore, the composite oxide particle 41 will not come in contact with one another and cohere with one another at high temperatures, thereby diminishing deterioration of the catalyst activity by grain growth. Although the composite oxide particle 41 is caged within the metallic oxide 45, the metallic oxide 45 is a porous material having an air-permeability; therefore, the exhaust gas sufficiently reaches the composite oxide particle 41 for purification by the precious metallic component contained therein. Accordingly, the function of the active precious metals is not compromised.

In each embodiment of the exhaust gas purification catalyst, the promoter component particle 14 is, for example, an oxide including at least one of Mn, Fe, Ni, Co, Cu and Zn. The high heat-resistant oxide 15 comprises at least ZrO₂ or a composite oxide containing ZrO₂ as the promoter clathrate 16 and may further comprise at least one of CeO₂, Y₂O₃, La₂O₃, CaO and Nd₂O₃. ZrO₂ has a porous shape, and the shape can be maintained without reacting with the promoter component particle in an exhaust gas environment. CeO₂, Y₂O₃, La₂O₃, CaO or Nd₂O₃, when used, serves as a stabilizer for the heat resistance of the high heat-resistant oxide 15 when the high heat-resistant oxide 15 includes ZrO₂.

In the embodiments of tie catalyst disclosed herein, the promoter component is not limited to Mn, Fe, Co, Cu and Zn. The promoter component may be an oxide including at least one of Ce, La, Nd, Pr, Sm and Dy oxides. When the promoter component is at least one of Ce. La, Nd, Pr, Sm and Dy oxides, the high heat-resistant oxide 15 for covering the promoter component particle 14 includes at least Al₂O₃ and can beta combination of Al₂O₃ and at least one species of CeO₂, Y₂O₃, La₂O₃ and Nd₂O₃. This is because Al₂O₃ may have heat resistance and porous shape, and the shape of the promoter clathrate 16 can be maintained without reacting with the oxide for the promoter when using the catalyst for purification of exhaust gas.

Additional combination examples of the promoter component particle 14 and the high heat-resistant oxide are:
(1) Combination wherein the promoter component particle 14 is Mn oxide and the high heat-resistant oxide 15 is ZiO₂—Y₂O₃;
(2) Combination wherein the promoter component particle 14 is Fe oxide and the high heat-resistant oxide 15 is ZrO₂—Y₂O₃;
(3) Combination wherein the promoter component particle 14 is Ni oxide and the high heat-resistant oxide 15 is ZrO₂—Y₂O₃;
(4) Combination wherein the promoter component particle 14 is Co oxide and the high heat-resistant oxide 15 is ZrO₂—Y₂O₃;
(5) Combination wherein the promoter component particle 14 is Ce oxide and the high heat-resistant oxide 15 is Al₂O₃; and
(6) Combination wherein the promoter component particle 14 is CeO₂—ZrO₂ oxide and the high heat-resistant oxide 15 is Al₂O₃.

These are only examples of appropriate combinations and are not intended to be a complete list. The catalyst is not limited to Combinations (1) to (6).

In the embodiments of the catalyst as disclosed herein, the precious metallic particles are, for example, at least one of Pt, Pd, Rh, Au, Ag, Ir and Ru. The precious metallic particles are born in the bearing body, i.e., the metallic oxide particle, by impregnation.

In the catalyst 30 shown in FIG. 1, the-metallic oxide particle 32 for bearing the precious metallic particle 31 comprises at least one metallic oxide selected from Al₂O₃, CeO₂, ZrO₂, Y₂O₃, La₂O₃ and Nd₂O₃. When the metallic oxide particle 32 for bearing the precious metallic particle 31 is at least one of Al₂O₃, CeO₂, ZrO₂, Y₂O₃, La₂O₃ and Nd₂O₃, the metallic oxide 35 is an appropriate metallic oxide for covering the precious metallic particle 31.

In the catalyst 40 shown in FIG. 2, the precious metal for constituting the composite oxide particle 41 is selected from at least one of Pt, Pd, Rh, Au, Ag, Ir and Ru. The rare-earth elements for forming the composite oxide particle 41 with the precious metal are selected from at least one of La, Ce, Pi, Nd and Sm. Since the composite oxide particle 41 has heat resistance, the decomposition of the precious metallic oxide is restrained even under a high temperature environment so that the heat resistance of the catalyst 40 for purifying exhaust gas is improved.

The metallic oxide 45 covering the composite oxide particle 41 comprises at least one of Al₂O₃, CeO₂, ZrO₂, Y₂O₃, La₂O₃ and Nd₂O₃.

In order to produce the catalyst 30 shown in FIG. 1, for example, a catalytic active species is produced by adding a colloid solution of the precious metal to a solution containing a material zol of the metallic oxide and the metallic oxide for bearing, and then stirring and drying the solution. Further, to provide the promoter clathrate 16, the promoter particle is colloidized by mixing with a high molecular protecting material. Then, the material for clathrating the promoter particle with a precursor of the high heat-resistant oxide is produced by mixing and stirring the colloid solution and the precursor of the high heat-resistant oxide. Subsequently, a powder of the catalyst shown in FIG. 1 can be obtained by mixing and then drying or sintering the catalytic active species and the material of the promoter clathrate in the solution.

In order to produce the catalyst 40 shown in the embodiment of FIG. 2, for example, a composite oxide powder is formed by mixing the precious metallic material solution and the rare-earth elements material solution and depositing a composite oxide precursor containing the precious metal and the rare-earth elements therein, and then filtering, drying and plasticizing the composite oxide precursor. Subsequently, a powder of the catalyst shown in FIG. 2 can be obtained by forming a heat resistant oxide precursor to be deposited around a particle of the composite oxide powder by mixing the composite oxide powder and the heat resistant oxide material solution, and then filtering, drying and plasticizing the heat resistant oxide precursor.

Embodiments of the catalyst taught herein are further described below.

### EMBODIMENT 1

Embodiment 1 is an example of the catalyst for purifying exhaust gas shown in FIG. 1, wherein the promoter component is manganese oxide, the high heat-resistant oxide for covering the promoter is zirconia solid solution, and-the catalytic active species is a catalyst for bearing Pt with CeO₂ and clathrating it with alumina.

(a) Production of Promoter Clathrate

Manganese oxide suspension is obtained by adding 10.0 g of manganese oxide into 200 g of water and mixing it, and then adding 10.0 g of polyvinylpyrrolidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the manganese oxide suspension previously produced are added, and then stirred again.

(b) Production of Precious Metallic Anchor Clathrate

200.27 g of aluminum isopropoxide and 57.11 g of acetylacetonato cerium are added into 1792 g of 2-methyl-2,4-pentanediol, and then stirred and dissolved. After the dissolution, 75 g of polyvinylpyrrolidone Pt (Pt: 4 wt %)is added thereto while being stirred. A dried powder is obtained by decompressing and drying the mixture.

(c) Production of Promoter Clathrate+Precious Metallic Clathrate

A dried powder of precious metallic clathrate is added into the mixed solution of the manganese oxide suspension and tile zirconia-yttria precursor previously produced, and then stirred again.

After being stirred, a supernatant is thrown away by calming. Then, moisture is evaporated by leaving the solution in a thermostat at 150° C. for a day. The catalytic powder is obtained by plasticizing the dried powder at 400° C. for one hour.

### EMBODIMENT 2

Embodiment 2 is an example of the catalyst for purifying exhaust gas shown in FIG. 1 wherein the promoter component is iron-oxide, the high heat-resistant oxide for covering the promoter is zirconia solid solution, and the catalytic active species is a catalyst for bearing Pt with CeO₂ and clathrating it with alumina.

(a) Production of Promoter Clathrate

Iron oxide suspension is obtained by adding 10.0 g of iron oxide into 200 g of water and mixing it, and then adding 10.0 g of polyvinylpyrrolidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the iron oxide suspension previously produced are added, and then stirred again.

(b) Production of Precious Metallic Anchor Clathrate

200.27 g of aluminum isopropoxide and 57.11 g of acetylacetonato cerium are added into 1792 g of 2-methyl-2,4-pentanediol, and then stirred and dissolved. After the dissolution, 75 g of polyvinylpyrrolidone Pt (Pt: 4 wt %) is added thereto while being stirred. A dried powder is obtained by decompressing and drying the mixture.

(c) Production of Promoter Clathrate+Precious Metallic Clathrate

A dried powder of precious metallic clathrate is added into the mixed solution of the iron oxide suspension and the zirconia-yttria precursor mixture previously produced, and then stirred again.

After being stirred, a supernatant is thrown away by calming. Then, moisture is evaporated by leaving the solution in a thermostat at 150° C. for a day. The catalytic powder is obtained by plasticizing the dried powder at 400° C. for one hour.

### EMBODIMENT 3

Embodiment 3 is an example of the catalyst for purifying exhaust gas shown in FIG. 1, wherein the promoter component is nickel oxide, the high heat-resistant oxide for covering the promoter is zirconia solid solution, and the catalytic active species is a catalyst for bearing Pt with CeO₂ and clathrating it with alumina.

(a) Production of Promoter Clathrate

Oxide nickel suspension is obtained by adding 10.0 g of nickel oxide into 200 g water and mixing it, and then adding 10.0 g of polyvinylpyrrolidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the nickel oxide suspension previously produced are added, and then stirred again.

(b) Production of Precious Metallic Anchor Clathrate

200.27 g of aluminum isopropoxide and 57.11 g of acetylacetonato cerium are added into 1792 g of 2-methyl-2,4-pentanediol, and then stirred and dissolved. After the dissolution, 75 g of polyvinylpyrrolidone Pt (Pt: 4 wt %) is added thereto while being stirred. A dried powder is obtained by decompressing and drying the mixture.

(c) Production of Promoter Clathrate+Precious Metallic Clathrate

A dried powder of the precious metallic clathrate is added into the mixed solution of the nickel oxide suspension and the zirconia-yttria precursor previously produced, and then stirred again.

After being stirred, a supernatant is thrown away by calming, and then moisture is evaporated by leaving the solution in a thermostat at 150° C. for a day. The catalytic powder is obtained by plasticizing the dried powder at 400° C. for one hour.

### EMBODIMENT 4

Embodiment 4 is an example of the catalyst for purifying exhaust gas shown in FIG. 1, wherein the promoter component is cobalt oxide, the high heat-resistant oxide for covering the promoter is zirconia solid solution, and the catalytic active species is a catalyst for bearing Pt with CeO₂ and clathrating it with alumina.

(a) Production of Promoter Clathrate

Cobalt oxide suspension is obtained by adding 10.0 g of cobalt oxide into 200 g of water and mixing it, and then adding 10.0 g of polyvinylpyrrolidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the cobalt oxide suspension previously produced are added, and then stirred again.

(b) Production of Precious Metallic Anchor Clathrate

200.27 g of aluminum isopropoxide and 57.11 g of acetylacetonato cerium are added into 1792 g of 2-methyl-2,4-pentanediol, and then stirred and dissolved. After the dissolution, 75 g of polyvinylpyrrolidone Pt (Pt: 4 wt %) is added thereto while being stirred. A dried powder is obtained by decompressing and drying the mixture.

(c) Production of Promoter Clathrate+Precious Metallic Clathrate

A dried powder of precious metallic clathrate is added into the mixed solution of the cobalt oxide suspension and the zirconia-yttria precursor previously produced, and then stirred again.

After being stirred, a supernatant is thrown away by calming, and then moisture is evaporated by leaving the solution in a thermostat at 150° C. for a day. The catalytic powder is obtained by plasticizing the dried powder at 400° C. for one hour.

### EMBODIMENT 5

Embodiment 5 is an example of the catalyst for purifying exhaust gas shown in FIG. 1, wherein the promoter component is cerium oxide, the high heat-resistant oxide for covering the promoter is alumina, and the catalytic active species is a catalyst for bearing Pt with CeO₂ and clathrating it with alumina.

(a) Production of Promoter Clathrate

Cerium oxide suspension is obtained by adding 10.0 g of cerium oxide into 200 g of water and mixing it, and then adding 10.0 g of polyvinylpyrrolidone thereto.

Separately, 112.36 g of hydration aluminum oxide is added into 2000 g of water and mixed. Then, the cerium oxide suspension previously produced is added thereto and stirred again.

(b) Production of Precious Metallic Anchor Clathrate

200.27 g of aluminum isopropoxide and 57.11 g of acetylacetonato cerium are added into 1792 g of 2-methyl-2,4-pentanediol, and then stirred and dissolved. After the dissolution, 75 g of polyvinylpyrrolidone Pt (Pt: 4 wt %) is added thereto while being stirred. A dried powder is obtained by decompressing and drying the mixture.

(c) Production of Promoter Clathrate+Precious Metallic Clathrate

A dried powder of precious metallic clathrate is added into the mixed solution of the cerium oxide suspension and the hydration aluminum oxide previously produced, and then stirred again.

After being stirred, a supernatant is thrown away by calming. Then, moisture is evaporated by leaving the solution in a thermostat at 150° C. for a day. The catalytic powder is obtained by plasticizing the dried powder at 400° C. for one hour.

### EMBODIMENT 6

Embodiment 6 is an example of the catalyst for purifying exhaust gas shown in FIG. 1, wherein the promoter component is cerium oxide-zirconium oxide solid solution, the high heat-resistant oxide for covering the promoter is alumina, and the catalytic active species is a catalyst for bearing Pt with CeO₂ and clathrating it with alumina.

(a) Production of Promoter Clathrate

Cerium oxide-zirconium oxide solid solution suspension is obtained by adding 10.0 g of the cerium oxide-zirconium oxide solid solution (mol ratio of Ce:Zr=80:20) into 200 g of water and mixing it, and then adding 10.0 g of polyvinylpyrrolidone thereto.

Separately, 112.36 g of hydration aluminum oxide is added into 2000 g of water and mixed. Then, the cerium oxide-zirconium oxide solid solution suspension previously produced is added thereto and stirred again.

(b) Production of Precious Metallic Anchor Clathrate

200.27 g of aluminum isopropoxide and 57.11 g of acetylacetonato cerium are added into 1792 g of 2-methyl-2,4-pentanediol, and then stirred and dissolved. After the dissolution, 75 g of polyvinylpyrrolidone Pt (Pt: 4 wt %) is added thereto while being stirred. A dried powder is obtained by decompressing and drying the mixture.

(c) Production of Promoter Clathrate+Precious Metallic Clathrate

A dried powder of the precious metallic clathrate is added into the mixed solution of cerium oxide-zirconium oxide and hydration aluminum oxide previously produced, and then stirred again.

After being stirred, a supernatant is thrown away by calming. Then, moisture is evaporated by leaving the solution in a thermostat at 150° C. for a day. The catalytic powder is obtained by plasticizing tile dried powder at 400° C. for one hour.

### EMBODIMENT 7

Embodiment 7 is an example of the catalyst for purifying exhaust gas shown in FIG. 2, wherein the promoter component is manganese oxide, the high-heat-resistant oxide for covering the promoter is zircon ia solid solution, and the catalytic active species is a Pd—Nd composite oxide catalyst.

(a) Production of Promoter Clathrate

Manganese oxide suspension is obtained by adding 10.0 g of manganese oxide into 200 g of water, and then adding 10.0 g of polyvinylpyrrolidone thereto.

Separately, zircon ia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the manganese oxide suspension previously produced are added, and then stirred again.

(b) Production of Catalyst Composite Oxide Clathrate

49.094 g of nitric acid neodymium (Nd(NO₃)₃.6H₂O) and 28.342 g of nitric acid palladium solution (Pd 20.764 wt %) are added into 1000 g of water and mixed. Then, the 25% ammonia aqueous solution is distilled while being stirring until it becomes pH 11.

Subsequently, a supernatant is thrown away by filtering and washing with water, and then moisture is evaporated by leaving the solution in a thermostat at 150° C. for a day. The composite oxide powder is obtained by plasticizing the dried powder at 400° C. for one hour.

558.33 g of nitric acid aluminum (Al(NO₃)₃.9H₂O) and the composite oxide powder previously produced are added into 3000 g of water and mixed, and the 25% ammonia aqueous solution is distilled while being stirred until it becomes pH 9. Subsequently, a supernatant is thrown away by filtering and washing with water. Then, moisture is evaporated by leaving the solution in a thermostat at 150° C. for a day.

The powder obtained by drying is allowed to be a composite oxide catalytic active unit powder for arranging Al₂O₃ around the composite oxide powder by plasticizing the powder at 400° C. for an hour.

(c) Production of Promoter Clathrate+Precious Metallic Clathrate

The catalytic composite oxide dried powder is added into the mixed solution of the manganese oxide suspension and the zirconia-yttria precursor previously produced, and then stirred again.

After being stirred, a supernatant is thrown away by calming. Then, moisture is evaporated by leaving the solution in a thermostat at 150° C. for a day. The catalytic powder is obtained by plasticizing the dried powder at 400° C. for one hour.

### EMBODIMENT 8

Embodiment 8 is an example of the catalyst for purifying exhaust gas shown in FIG. 2, wherein the promoter component is iron oxide, the high heat-resistant oxide for covering the promoter is zirconia solid solution, and the catalytic active species is Pd—Nd composite oxide catalyst.

(a) Production of Promoter Clathrate

Iron oxide suspension is obtained by adding 10.0 g of the iron oxide into 200 g of water and mixing it, and then adding 10.0 g of polyvinylidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the manganese oxide suspension previously produced are added, and then stirred again.

(b) Production of Catalyst Composite Oxide Clathrate

49.094 g of nitric acid neodymium (Nd(NO₃)₃.6H₂O) and 28.342 g of nitric acid palladium solution (Pd 20.764 wt %) are added into 1000 g of water and mixed. Then, the 25% ammonia aqueous solution is distilled while being stirring until it becomes pH 11.

Subsequently, a supernatant is thrown away by filtering and washing with water. Then, moisture is evaporated by leaving the solution in a thermostat at 150° C. for a day. The composite oxide powder is obtained by plasticizing the dried powder at 400° C. for one hour.

558.33 g of nitric acid aluminum (Al(NO₃)₃.9H₂O) and the composite oxide powder previously produced are added into 3000 g of water and mixed, and the 25% ammonia aqueous solution is distilled while being stirred until it becomes pH 9. Subsequently, a supernatant is thrown away by filtering and washing with water. Then, moisture is evaporated by leaving the solution in a thermostat at 150° C. for a day.

The powder obtained by drying is allowed to be a composite oxide catalytic active unit powder for arranging Al₂O₃ around the composite oxide powder by plasticizing the powder at 400° C. for an hour.

(c) Production of Promoter Clathrate+Precious Metallic Clathrate

The catalytic composite oxide dried powder is added into the mixed solution of the iron oxide suspension and the zirconia-yttria precursor previously produced, and then stirred again.

After being stirred, a supernatant is thrown away by calming. Then, moisture is evaporated by leaving the solution in a thermostat at 150° C. for a day. The catalytic powder is obtained by plasticizing the dried powder at 400° C. for one hour.

### EMBODIMENT 9

Embodiment 9 is an example of the catalyst for purifying exhaust gas shown in FIG. 2, wherein the promoter component is nickel oxide, the high heat-resistant oxide for covering the promoter is zirconia solid solution, and the catalytic active species is a Pd—Nd composite oxide catalyst.

(a) Production of Promoter Clathrate

Nickel oxide suspension is obtained by adding 10.0 g of nickel oxide into 200 g of water and mixing it, and then adding 10.0 g of polyvinylidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the manganese oxide suspension previously produced are added, and then stirred again.

(b) Production of Catalyst Composite Oxide Clathrate

49.094 g of nitric acid neodymium (Nd(NO₃)₃.6H₂O) and 28.342 g. of nitric acid palladium solution (Pd 20.764 wt %) are added into 1000 g of water and mixed. Then, the 25% ammonia aqueous solution is distilled while being stirring until it becomes pH 11.

Subsequently, a supernatant is thrown away by filtering and washing with water. Then, moisture is evaporated by leaving the solution in a thermostat at 150° C. for a day. The composite oxide powder is obtained by plasticizing the dried powder at 400° C. for one hour.

558.33 g of nitric acid aluminum (Al(NO₃)₃.9H₂O) and the composite oxide powder previously produced are added into 3000 g of water and mixed. Then, the 25% ammonia aqueous solution is distilled while being stirred until it becomes pH 9. Subsequently, a supernatant is thrown away by filtering and washing with water. Then, moisture is evaporated by leaving the solution in a thermostat at 150° C. for a day.

The powder obtained by drying is allowed to be a composite oxide catalytic active unit powder for arranging Al₂O₃ around the composite oxide powder by plasticizing the powder at 400° C. for an hour.

(c) Production of Promoter Clathrate+Precious Metallic Clathrate

The catalytic composite oxide dried powder is added into the mixed solution of the nickel oxide suspension and the zirconia-yttria precursor previously produced, and then stirred again.

After being stirred, a supernatant is thrown away by calming. Then, moisture is evaporated by leaving the solution in a thermostat at 150° C. for a day. The catalytic powder is obtained by plasticizing the dried powder at 400° C. for one hour.

### EMBODIMENT 10

Embodiment 10 is an example of the catalyst for purifying exhaust gas shown in FIG. 2, wherein the promoter component is cobalt oxide, the high heat-resistant oxide for covering the promoter is zirconia solid solution, and the catalytic active species is Pd—Nd composite oxide catalyst.

(a) Production of Promoter Clathrate

Cobalt oxide suspension is obtained by adding 10.0 g of cobalt oxide into 200 g of water and mixing it, and then adding 10.0 g of polyvinylidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the cobalt oxide suspension previously produced are added, and then stirred again.

(b) Production of Catalyst Composite Oxide Clathrate

49.094 g of nitric acid neodymium (Nd(NO₃)₃.6H₂O) and 28.342 g of nitric acid palladium solution (Pd 20.764 wt %) are added into 1000 g of water and mixed. Then, the 25% ammonia aqueous solution is distilled while being stirring until it becomes pH 11.

Subsequently, a supernatant is thrown away by filtering and washing with water. Then, moisture is evaporated by leaving the solution in a thermostat at 150° C. for a day. The composite oxide powder is obtained by plasticizing the dried powder at 400° C. for one hour.

558.33 g of nitric acid aluminum (Al(NO₃)₃.9H₂O) and the composite oxide powder previously produced are added into 3000 g of water and mixed. Then, the 25% ammonia aqueous solution is distilled while being stirred until it becomes pH 9. Subsequently, a supernatant is thrown away by filtering and washing with water. Then, moisture is evaporated by leaving the solution in a thermostat at 150° C. for a day.

The powder obtained by drying is allowed to be a composite oxide catalytic active unit powder for arranging Al₂O₃ around the composite oxide powder by plasticizing the powder at 400° C. for an hour.

(c) Production of Promoter Clathrate+Precious Metallic Clathrate

The catalytic composite oxide dried powder is added into the mixed solution of the cobalt oxide suspension and the zirconia-yttria precursor previously produced, and then stirred again.

After being stirred, a supernatant is thrown away by calming. Then, moisture is evaporated by leaving the solution in a thermostat at 150° C. for a day. The catalytic powder is obtained by plasticizing the dried powder at 400° C. for one hour.

### EMBODIMENT 11

Embodiment 11 is an example of the catalyst for purifying exhaust gas shown in FIG. 2, wherein the promoter component is cerium oxide, the high heat-resistant oxide for covering the promoter is alumina, and the catalytic active species is Pd—Nd composite oxide.

(a) Promoter Clathrate

Cerium oxide suspension is obtained by adding 10.0 g of cerium oxide into 200 g of water and mixing it, and then adding 10.0 g of polyvinylidone thereto.

Separately, 112.36 g of hydration aluminum oxide is added into 2000 g of water and mixed. Then, the cerium oxide suspension previously produced is added thereto and stirred again.

(b) Catalyst Composite Oxide Clathrate

49.094 g of nitric acid neodymium (Nd(NO₃)₃.6H₂O) and 28.342 g of nitric acid palladium solution (Pd 20.764 wt %) are added into 1000 g of water and mixed. Then, the 25% ammonia aqueous solution is distilled while being stirring until it becomes pH 11.

Subsequently, a supernatant is thrown away by filtering and washing with water. Then, moisture is evaporated by leaving the solution in a thermostat at 150° C. for a day. The composite oxide powder is obtained by plasticizing the dried powder at 400° C. for one hour.

558.33 g of nitric acid aluminum (Al(NO₃)₃.9H₂O) and the composite oxide powder previously produced are added into 3000 g of water and mixed. Then, the 25% ammonia aqueous solution is distilled while being stirred until it becomes pH 9. Subsequently, a supernatant is thrown away by filtering and washing with water. Then, moisture is evaporated by leaving the solution in a thermostat at 150° C. for a day.

The powder obtained by drying is allowed to be a composite oxide catalytic active unit powder for arranging Al₂O₃ around the composite oxide powder by plasticizing the powder at 400° C. for an hour.

(c) Production of Promoter Clathrate+Precious Metallic Clathrate

The catalytic composite oxide dried powder is added into the mixed solution of the cerium oxide suspension and the zirconia-yttria precursor previously produced, and then stirred again.

After being stirred, a supernatant is thrown away by calming. Then, moisture is evaporated by leaving the solution in a thermostat at 150° C. for a day. Tile catalytic powder is obtained by plasticizing the dried powder at 400° C. for one hour.

### EMBODIMENT 12

Embodiment 12 is an example of the catalyst for purifying exhaust gas shown in FIG. 2, wherein the promoter component is cerium oxide-zirconium oxide solid solution, the high heat-resistant oxide for covering the promoter is alumina, and the catalytic active species is Pd—Nd composite oxide catalyst.

(a) Production of Promoter Clathrate

Cerium oxide-zirconium oxide solid solution suspension is obtained by adding 10.0 g of the cerium oxide-zirconium oxide solid solution (mol ratio of Ce:Zr=80:20) into 200 g of water and mixing it, and then adding 10.0 g of polyvinylpyrrolidone thereto.

Separately, 112.36 g of hydration aluminum oxide is added into 2000 g of water and mixed. Then, the cerium oxide-zirconium oxide solid solution suspension previously produced is added thereto and stirred again.

(b) Production of Catalyst Composite Oxide Clathrate

49.094 g of nitric acid neodymium (Nd(NO₃)₃.6H₂O) and 28.342 g of nitric acid palladium solution (Pd 20.764 wt %) are added into 1000 g of water and mixed. Then, the 25% ammonia aqueous solution is distilled while being stirring until it becomes pH 11.

Subsequently, a supernatant is thrown away by filtering and washing with water. Then, moisture is evaporated by leaving the solution in a thermostat at 150° C. for a day. The composite oxide powder is obtained by plasticizing the dried. powder at 400° C. for one hour.

558.33 g of nitric acid aluminum (Al(NO₃)₃.9H₂O) and the composite oxide powder previously produced are added into 3000 g of water and mixed, and the 25% ammonia aqueous solution is distilled while being stirred until it becomes pH 9. Subsequently, a supernatant is thrown away by filtering and washing with water. Then, moisture is evaporated by leaving the solution in a thermostat at 150° C. for a day.

The powder obtained by drying is allowed to be a composite oxide catalytic active unit powder for arranging Al₂O₃ around the composite oxide powder by plasticizing the powder at 400° C. for one hour.

(c) Production of Promoter Clathrate+Precious Metallic Clathrate

The catalytic composite oxide dried powder is added into the mixed solution of the manganese oxide suspension and the zirconia-yttria precursor previously produced, and then stirred again.

After being stirred, a supernatant is thrown away by calming. Then, moisture is evaporated by leaving the solution in a thermostat at 150° C. for a day. The catalytic powder is obtained by plasticizing the dried powder at 400° C. for one hour.

### COMPARATIVE EXAMPLE 1

Comparative Example 1 is an example of a catalyst for purifying exhaust gas, which does not comprise a promoter clathrate.

Catalytic powder is obtained by impregnating 100 g of the aluminum oxide and the dinitrodiamine platinum such that Pt becomes 1.5 wt %.

### COMPARATIVE EXAMPLE 2

Comparative Example 2 is an example of a catalyst for purifying exhaust gas, which includes manganese oxide as promoter component but does not comprise a high heat-resistant oxide for covering the promoter component. Comparative Example 2 is an example comparable with Embodiment 2 wherein the catalytic active species is an impregnation catalyst.

Manganese oxide suspension is obtained by adding 5.0 g of manganese oxide into 200 g of water and mixing it, and then adding 5.0 g of polyvinylpyrrolidone thereto.

The catalytic powder and the manganese oxide suspension are added into 2000 g of water, and then stirred again wherein 100 g of the aluminum oxide and the dinitrodiamine platinum are impregnated in the catalytic powder such that the Pt becomes 3.0 wt %. After being stirred, a supernatant is thrown away by calming. Then, moisture is evaporated by leaving the solution in a thermostat at 150° C. for a day. The catalytic powder is obtained by plasticizing the dried powder at 400° C. for one hour.

### COMPARATIVE EXAMPLE 3

Comparative Example 3 is an example of a catalyst for purifying exhaust gas, which includes iron oxide as a promoter component but does not comprise a high heat-resistant oxide for covering the promoter component. Comparative Example 3 is an example comparable with Embodiment 2 wherein the catalytic active species is an impregnation catalyst.

Iron oxide suspension is obtained by adding 5.0 g of iron oxide into 200 g of water and mixing it, and then adding 5.0 g of polyvinylpyrrolidone thereto.

The catalytic powder and the iron oxide suspension are added into 2000 g of water and then stirred again, wherein 100 g of aluminum oxide and dinitrodiamine platinum are impregnated in the catalytic powder such that Pt becomes 3.0 wt %. After being stirred, a supernatant is thrown away by calming and then moisture is evaporated by leaving the solution in a thermostat at 150° C. for a day. The catalytic powder is obtained by plasticizing the dried powder at 400° C. for one hour.

### COMPARATIVE EXAMPLE 4

Comparative Example 4 is an example of a catalyst for purifying exhaust gas, which includes nickel oxide as a promoter component but does not comprise a high heat-resistant oxide for covering the promoter component. Comparative Example 4 is an example comparable with Embodiment 3 wherein the catalytic active species is an impregnation catalyst.

Nickel oxide suspension is obtained by adding 5.0 g of nickel oxide into 200 g of water and mixing it, and then adding 5.0 g of polyvinylpyrrolidone thereto.

The catalytic powder and the nickel oxide suspension are added into 2000 g of water and then stirred again, wherein 100 g of aluminum oxide and dinitrodiamine platinum are impregnated in the catalytic powder such that Pt becomes 3.0 wt %. After being stirred, a supernatant is thrown away by calming and then moisture is evaporated by leaving the solution in a thermostat at 150° C. for a day. The catalytic powder is obtained by plasticizing the dried powder at 400° C. for one hour.

### COMPARATIVE EXAMPLE 5

Comparative Example 5 is an example of a catalyst for purifying exhaust gas, which includes cobalt oxide as a promoter component but does not comprise a high heat-resistant oxide for covering the promoter component. Comparative Example 5 is an example comparable with Embodiment 4 wherein the catalytic active species is an impregnation catalyst.

Cobalt oxide suspension is obtained by adding 5.0 g of cobalt oxide into 200 g of water and mixing it, and then adding 5.0 g of polyvinylpyrrolidone thereto.

The catalytic powder and the cobalt oxide suspension are added into 2000 g of water and then stirred again, wherein 100 g of the aluminum oxide and the dinitrodiamine platinum are impregnated in the catalytic powder such that Pt becomes 3.0 wt %. After being stirred, a supernatant is thrown away by calming and then moisture is evaporated by leaving the solution in a thermostat at 150° C. for a day. The catalytic powder is obtained by plasticizing the dried powder at 400° C. for one hour.

### COMPARATIVE EXAMPLE 6

Comparative Example 6 is an example of a catalyst for purifying exhaust gas, which includes cerium oxide as a promoter component but does not comprise a high heat-resistant oxide for covering the promoter component. Comparative Example 6 is an example comparable with Embodiment 5 wherein the catalytic-active species is an impregnation catalyst.

Cerium oxide suspension is obtained by adding 5.0 g of cerium oxide into 200 g of water and mixing it, and then adding 5.0 g of polyvinylpyrrolidone thereto.

The catalytic powder and the cerium oxide suspension are added into 2000 g of water and then stirred again, wherein 100 g of the aluminum oxide and the dinitrodiamine platinum are impregnated in the catalytic powder such that the Pt becomes 3.0 wt %. After being stirred, a supernatant is thrown away by calming and then moisture is evaporated by leaving the solution in a thermostat at 150° C. for a day. The catalytic powder is obtained by plasticizing the dried powder at 400° C. for one hour.

### COMPARATIVE EXAMPLE 7

Comparative Example 7 is an example of a catalyst for purifying exhaust gas, which includes cerium oxide-zirconium oxide solid solution as a promoter component but does not comprise a high heat-resistant oxide for covering the promoter component. Comparative Example 7 is an example comparable with Embodiment 6 wherein the catalytic active species is an impregnation catalyst.

Cerium oxide-zirconium oxide solid solution suspension is obtained by adding 5.0 g of cerium oxide-zirconium oxide solid solution (mol ratio of Ce:Zr=80:20) into 200 g of water and mixing it, and then adding 5.0 g of polyvinylpyrrolidone thereto.

The catalytic powder and the cerium oxide-zirconium oxide solid solution suspension are-added into 2000 g of water and then stirred again, wherein 100 g of the aluminum oxide and the dinitrodiamine platinum are impregnated in the catalytic powder such that the Pt becomes 3.0 wt %. After being stirred, a supernatant is thrown away by calming and then moisture is evaporated by leaving the solution in a thermostat at 150° C. for a day. The catalytic powder is obtained by plasticizing the dried powder at 400° C. for one hour.

### COMPARATIVE EXAMPLE 8

Comparative Example 8 is an example of using Pd as a precious metallic component instead of Pt, which is a precious metallic component of Comparative Example 1. All other constituents except the above are the same as Comparative Example 1.

Catalytic powder is obtained by impregnating 100 g of the aluminum oxide and nitric acid palladium such that Pd becomes 3.5 wt %.

### COMPARATIVE EXAMPLE 9

Comparative Example 9 is an example of using Pd as a precious metallic component instead of Pt, which is a precious metallic component of Comparative Example 2. All other constituents except the above are the same as Comparative Example 2.

Manganese oxide suspension is obtained by adding 5.0 g of manganese oxide into 200 g of water and mixing it, and then adding 5.0 g of polyvinylpyrrolidone thereto.

The catalytic powder and the manganese oxide suspension are added into 2000 g of water and then stirred again, wherein 100 g of the aluminum oxide and the nitric acid palladium are impregnated in the catalytic powder such that Pd becomes 7.0 wt %. After being stirred, a supernatant is thrown away by calming and then moisture is evaporated by leaving the solution in a thermostat at 150° C. for a day. The catalytic powder is obtained by plasticizing the dried powder at 400° C. for one hour.

### COMPARATIVE EXAMPLE 10

Comparative Example 10 is an example of using Pd as a precious metallic component instead of Pt, which is a precious metallic component of Comparative Example 3. All other constituents except the above are the same as Comparative Example 3.

Iron oxide suspension is obtained by adding 5.0 g of iron oxide into 200 g of water and mixing it, and then adding 5.0 g of polyvinylpyrrolidone thereto.

The catalytic powder and the iron oxide suspension are added into 2000 g of water and then stirred again, wherein 100 g of the aluminum oxide and the nitric acid palladium are impregnated in the catalytic powder such that the Pd becomes 7.0 wt %. After being stirred, a supernatant is thrown away by calming and then moisture is evaporated by leaving the solution in a thermostat at 150° C. for a day. The catalytic powder is obtained by plasticizing the dried powder at 400° C. for one

### COMPARATIVE EXAMPLE 11

Comparative Example 11 is an example of using Pd as a precious metallic component instead of Pt, which is a precious metallic component of Comparative Example 4. All other constituents except the above are the same as Comparative Example 4.

Nickel oxide suspension is obtained by adding 5.0 g of nickel oxide into 200 g of water and mixing it, and then adding 5.0 g of polyvinylpyrrolidone thereto.

The catalytic powder and the nickel oxide suspension are added into 2000 g of water and then stirred again, wherein 100 g of the aluminum oxide and the 7.0 wt %. After being stirred, a supernatant is thrown away by calming and then moisture is evaporated by leaving the solution in a thermostat at 150° C. for a day. The catalytic powder is obtained by plasticizing the dried powder at 400° C. for one hour.

### COMPARATIVE EXAMPLE 12

Comparative Example 12 is an example of using Pd as a precious metallic component instead of Pt, which is a precious metallic component of Comparative Example 5. All other constituents except the above are the same as Comparative Example 5.

Cobalt oxide suspension is obtained by adding 5.0 g of cobalt oxide into 200 g of water and mixing it, and then adding 5.0 g of polyvinylpyrrolidone thereto.

The catalytic powder and the cobalt oxide suspension are added into 2000 g of water and then stirred again, wherein 100 g of the aluminum oxide and the nitric acid palladium are impregnated in the catalytic powder such that Pd becomes 7.0 wt %. After being stirred, a supernatant is thrown away by calming and then moisture is evaporated by leaving the solution in a thermostat at 150° C. for a day. The catalytic powder is obtained by plasticizing the dried powder at 400° C. for one hour.

### COMPARATIVE EXAMPLE 13

Comparative Example 13 is an example of using Pd as a precious metallic component instead of Pt, which is a precious metallic component of Comparative Example 6. All other constituents except the above are the same as Comparative Example 6.

Cerium oxide suspension is obtained by adding 5.0 g of cerium oxide into 200 g of water and mixing it, and then adding 5.0 g of polyvinylpyrrolidone thereto.

The catalytic powder and the cerium oxide suspension are added into 2000 g of water and then stirred again, wherein 100 g of the aluminum oxide and the nitric acid palladium are impregnated in the catalytic powder such that Pd becomes 7.0 wt %. After being stirred, a supernatant is thrown away by calming and then moisture is evaporated by leaving the solution in a thermostat at 150° C. for a day. The catalytic powder is obtained by plasticizing the dried powder at 400° C. for one hour.

### COMPARATIVE EXAMPLE 14

Comparative Example 14 is an example of using Pd as a precious metallic component instead of Pt, which is a precious metallic component of Comparative Example 7. All other constituents except the above are the same as Comparative Example 7.

Cerium oxide-zirconium oxide solid solution suspension is obtained by adding 5.0 g of cerium oxide-zirconium oxide solid solution (mol ratio of Ce:Zr=80:20) into 200 g of water and mixing it, and then adding 5.0 g of polyvinylpyrrolidone thereto.

The catalytic powder and the cerium oxide suspension are added into 2000 g of water and then stirred again, wherein 100 g of the aluminum oxide and the nitric acid palladium are impregnated in the catalytic powder such that Pd becomes 7.0 wt %. After being stirred, a supernatant is thrown away by calming and then moisture is evaporated by leaving the solution in a thermostat at 150° C. for a day. The catalytic powder is obtained by plasticizing the dried powder at 400° C. for one hour.

### COMPARATIVE EXAMPLE 15

Comparative Example 15 is an example of a catalyst for purifying exhaust gas wherein a promoter component is manganese oxide, a high heat-resistant oxide for covering the promoter is zirconia-based solid solution and a catalytic active species is an impregnation catalyst.

Manganese oxide suspension is obtained by adding 10.0 g of manganese oxide into 200 g of water and mixing it, and then adding 10.0 g of polyvinylpyrrolidone thereto.

Separately, zirconia-ytrria precursor is obtained by adding 420.78 g of nitric acid zirconyl (ZrO(NO₃)₂.2H₂O) and 4.66 g of nitric acid yttrium. (Y(NO₃)₃.6H₂0) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the manganese oxide suspension previously produced are added and then stirred again.

Further, the catalytic powder is added thereto and then stirred again, wherein 100 g of aluminum oxide and dinitrodiamine platinum are impregnated in the catalytic powder such that Pt becomes 3 wt %.

After being stirred, a supernatant is thrown away by calming. Then, moisture is evaporated by leaving the solution in a thermostat at 100° C. for a day. The catalytic powder is obtained by plasticizing the dried powder at 400° C. for one hour.

### COMPARATIVE EXAMPLE 16

Comparative Example 16 is an example of a catalyst for purifying exhaust gas wherein a promoter component is iron oxide, a high heat-resistant oxide for covering the promoter is zirconia-based solid solution, and a catalytic active species is an impregnation catalyst.

Iron oxide suspension is obtained by adding 10.0 g of iron oxide into 200 g of water and mixing it, and then adding 10.0 g of polyvinylidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the iron oxide suspension previously produced are added and then stirred again.

Further, the catalytic powder is added thereto and then stirred again, wherein 100 g of aluminum oxide and dinitrodiamine platinum are impregnated in the catalytic powder such that the Pt becomes 3 wt %.

After being stirred, a supernatant is thrown away by calming. Then, moisture is evaporated by leaving the solution in a thermostat at 100° C. for a day. The catalytic powder is obtained by plasticizing the dried powder at 400° C. for one hour.

### COMPARATIVE EXAMPLE 17

Comparative Example 17 is an example of a catalyst for purifying exhaust gas wherein a promoter component is nickel oxide, a high heat-resistant oxide is zirconia-based solid solution, and a catalytic active species is an impregnation catalyst.

Nickel oxide suspension is obtained by adding 10.0 g of nickel oxide into 200 g of water and mixing it, and then adding 10.0 g of polyvinylpyrrolidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the nickel oxide suspension previously produced are added and then stirred again.

Further, the catalytic powder is added thereto and then stirred again, wherein 100 g of aluminum oxide and dinitrodiamine platinum are impregnated in the catalytic powder such that Pt becomes 3 wt %.

After being stirred, a supernatant is thrown away by calming. Then, moisture is evaporated by leaving the solution in a thermostat at 100° C. for a day. The catalytic powder is obtained by plasticizing the dried powder at 400° C. for one hour.

### COMPARATIVE EXAMPLE 18

Comparative Example 18 is an example of a catalyst for purifying exhaust gas wherein a promoter component is cobalt oxide, a high heat-resistant oxide is zirconia-based solid solution, and a catalytic active species is an impregnation catalyst.

Cobalt oxide suspension is obtained by adding 10.0 g of cobalt oxide into 200 g of water and mixing it, and then adding 10.0 g of polyvinylpyrrolidone thereto.

Separately, zirconia-ytrria precursor is obtained by adding 420.78 g of nitric acid zirconyl (ZrO(NO₃)₂.2H₂O), and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the cobalt oxide suspension previously produced are added and then stirred again.

Further, the catalytic powder is added thereto and then stirred again, wherein 100 g of aluminum oxide and dinitrodiamine platinum are impregnated in the catalytic powder such that Pt becomes 3 wt %.

After being stirred, a supernatant is thrown away by calming. Then, moisture is evaporated by leaving the solution in a thermostat at 100° C. for a day. The catalytic powder is obtained by plasticizing the dried powder at 400° C. for one hour.

### COMPARATIVE EXAMPLE 19

Comparative Example 19 is an example of a catalyst for purifying exhaust gas wherein a promoter component is cerium oxide, a high heat-resistant oxide is alumina, and a catalytic active species is an impregnation catalyst.

Cerium oxide suspension is obtained by adding 10.0 g of cerium oxide into 200 g of water and mixing it, and then adding 10.0 g of polyvinylpyrrolidone thereto.

Separately, 112.36 g of hydration aluminum oxide is added into 2000 g of water and mixed. Then, the cerium oxide suspension previously produced is added thereto and stirred again.

Further, the catalytic powder is added thereto and then stirred again, wherein 100 g of aluminum oxide and dinitrodiamine platinum are impregnated in the catalytic powder such that Pt becomes 3 wt %.

After being stirred, a supernatant is thrown away by calming. Then, moisture is evaporated by leaving the solution in a thermostat at 100° C. for a day. The catalytic powder is obtained by plasticizing the dried powder at 400° C. for one hour.

### COMPARATIVE EXAMPLE 20

Comparative Example 20 is an example of a catalyst for purifying exhaust gas wherein a promoter component is cerium oxide-zirconium oxide solid solution, a high heat-resistant oxide for covering the promoter is alumina, and a catalytic active species is an impregnation catalyst.

Cerium oxide-zirconium oxide solid solution suspension is obtained by adding 10.0 g of cerium oxide-zirconium oxide solid solution (mol ratio of Ce:Zr=80:20) into 200 g of water and mixing it, and then adding 10.0 g of polyvinylpyrrolidone thereto.

Separately, 112.36 g of hydration aluminum oxide is added into 2000 g of water and mixed. Then, the cerium oxide-zirconium oxide solid solution suspension previously produced is added thereto and stirred again.

Further, the catalytic-powder is added thereto and then stirred again, wherein 100 g of aluminum oxide and dinitrodiamine platinum are impregnated in the catalytic powder such that Pt becomes 3 wt %.

After being stirred, a supernatant is thrown away by calming. Then, moisture is evaporated by leaving the solution in a thermostat at 100° C. for a day. The catalytic powder is obtained by plasticizing the dried powder at 400° C. for one hour.

### COMPARATIVE EXAMPLE 21

Comparative Example 21 is an example of a catalyst for purifying exhaust gas wherein a promoter component is manganese oxide, a high heat-resistant oxide for covering the promoter is zirconia solid solution, and a catalytic active species is Pt clathrate catalyst.

Manganese oxide suspension is obtained by adding 10.0 g of manganese oxide into 200 g of water and mixing it, and then adding 10.0 g of polyvinylpyrrolidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the manganese oxide suspension previously produced are added, and then stirred again.

200.27 g of aluminum isopropoxide is added into 1792 g of 2-methyl-2,4-pentanediol and then stirred and dissolved. After the dissolution, 75 g of polyvinylpyrrolidone Pt (Pt: 4 wt %) is added thereto while being stirred. A dried powder is obtained by decompressing and drying the mixture.

A dried powder of precious metallic clathrate is added into the mixed solution of the manganese oxide suspension and the zirconia-yttria precursor previously produced, and then stirred again.

After being, stirred, a supernatant is thrown away by calming. Then, moisture is evaporated by leaving the solution in a thermostat at 150° C. for a day. The catalytic powder is obtained by plasticizing the dried powder at 400° C. for one hour.

### COMPARATIVE EXAMPLE 22

Comparative Example 22 is an example of a catalyst for purifying exhaust gas wherein a promoter component is iron oxide, a high heat-resistant oxide for covering the promoter is zirconia solid solution, and a catalytic active species is Pt clathrate catalyst.

Iron oxide suspension is obtained by adding 10.0 g of iron oxide into 200 g of water and mixing it, and then adding 10.0 g of polyvinylpyrrolidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the iron oxide suspension previously produced are added, and then stirred again.

200.27 g of aluminum isopropoxide is added into 1792 g of 2-methyl-2,4-pentanediol, and then stirred, and dissolved. After the dissolution, 75 g of polyvinylpyrrolidone Pt (Pt: 4 wt %) is added thereto while being stirred. A dried powder is obtained by decompressing and drying the mixture.

A dried powder of the precious metallic clathrate is added into the mixed solution of the iron oxide suspension and the zirconia-yttria precursor previously produced, and then stirred again.

After being stirred, a supernatant is thrown away by calming. Then, moisture is evaporated, by leaving the solution in a thermostat at 150° C. for a day. The catalytic powder is obtained by plasticizing the dried powder at 400° C. for one hour.

### COMPARATIVE EXAMPLE 23

Comparative Example 23 is an example of a catalyst for purifying exhaust gas wherein a promoter component is nickel oxide, a high heat-resistant oxide for covering the promoter is zirconia solid solution, and a catalytic active species is Pt clathrate catalyst.

Nickel oxide suspension is obtained by adding 10.0 g of nickel oxide into 200 g of water and mixing it, and then adding 10.0 g of polyvinylpyrrolidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the nickel oxide suspension previously produced are added, and then stirred again.

200.27 g of aluminum isopropoxide is added into 1792 g of 2-methyl-2,4-pentanediol, and then stirred and dissolved. After the dissolution, 75 g of polyvinylpyrrolidone Pt (Pt: 4 wt %) is added thereto while being stirred. A dried powder is obtained by decompressing and drying the mixture.

A dried powder of precious metallic clathrate is added into the mixed solution of the nickel oxide suspension and the zirconia-yttria precursor previously produced, and then stirred again.

After being stirred, a supernatant is thrown away by calming. Then, moisture is evaporated by leaving the solution in a thermostat at 150° C. for a day. The catalytic powder is obtained by plasticizing the dried powder at 400° C. for one hour.

### COMPARATIVE EXAMPLE 24

Comparative Example 10 is an example of a catalyst for purifying exhaust gas, wherein a promoter component is cobalt oxide, a high heat-resistant oxide for covering the promoter is zirconia solid solution, and a catalytic active species is Pt clathrate catalyst.

Cobalt oxide suspension is obtained by adding 10.0 g of cobalt oxide into 200 g of water and mixing it, and then adding 10.0 g of polyvinylpyrrolidone thereto.

Separately, zirconia-ytrria precursor is obtained by adding 420.78 g of nitric acid zirconyl (ZrO(NO₃)₂.2H₂O) and 4.66 g of nitric acid yttrium (Y(NO₃)₃.6H₂O) into 2000 g of water and mixing it, and then distilling while stirring until the 25% ammonia aqueous solution becomes pH 11. Subsequently, zirconia-yttrium precursor cake is obtained by filtering and washing sediment thereof with water. Such a cake, 2000 g of water and the cobalt oxide suspension previously produced are added, and then stirred again.

200.27 g of aluminum isopropoxide is added into 1792 g of 2-methyl-2,4-pentanediol, and then stirred and dissolved. After the dissolution, 75 g of polyvinylpyrrolidone Pt (Pt: 4 wt %) is added thereto while being stirred. A dried powder is obtained by decompressing and drying the mixture.

A dried powder of the precious metallic clathrate is added into the mixed solution of the cobalt oxide suspension and the zirconia-yttria precursor previously produced, and then stirred again.

After being stirred, a supernatant is thrown away by calming. Then, moisture is evaporated by leaving the solution in a thermostat at 150° C. for a day. The catalytic powder is obtained by plasticizing the dried powder at 400° C. for one hour.

### COMPARATIVE EXAMPLE 25

Comparative Example 25 is an example of a catalyst for purifying exhaust gas wherein a promoter component is cerium oxide, a high heat-resistant oxide for covering the promoter is alumina, and a catalytic active species is Pt clathrate catalyst.

Cerium oxide suspension is obtained by adding 10.0 g of cerium oxide into 200 g of water and mixing it, and then adding 10.0 g of polyvinylpyrrolidone thereto.

Separately, 112.36 g of hydration aluminum oxide is added into 2000 g of water and mixed. Then, the cerium oxide suspension previously produced is added thereto and stirred again.

200.27 g of aluminum isopropoxide is added into 1792 g of 2-methyl-2,4-pentanediol, and then stirred and dissolved. After the dissolution, 75 g of polyvinylpyrrolidone Pt (Pt: 4 wt %) is added thereto while being stirred. A dried powder is obtained by decompressing and drying the mixture.

A dried powder of precious metallic clathrate is added into the mixed solution of the cerium oxide suspension and hydration aluminum oxide previously produced, and then stirred again.

After being stirred, a supernatant is thrown away by calming. Then, moisture is evaporated by leaving the solution in a thermostat at 150° C. for a day. The catalytic powder is obtained by plasticizing the dried powder at 400° C. for one hour.

### COMPARATIVE EXAMPLE 26

Comparative Example 26 is an example of a catalyst for purifying exhaust gas wherein a promoter component is cerium oxide-zirconium oxide solid solution, a high heat-resistant oxide for covering the promoter is alumina, and a catalytic active species Pt clathrate catalyst.

Cerium oxide-zirconium oxide solid solution suspension is obtained by adding 10.0 g of the cerium oxide-zirconium oxide solid solution (mol ratio of Ce:Zr=80:20) into 200 g of water and mixing it, and then adding 10.0 g of polyvinylpyrrolidone thereto.

Separately, 112.36 g of hydration aluminum oxide is added into 2000 g of water and mixed. Then, the cerium oxide-zirconium oxide solid solution suspension previously produced is added thereto and stirred again.

200.27 g of aluminum isopropoxide is added into 1792 g of 2-methyl-2,4-pentanediol and then stirred and dissolved. After the dissolution, 75 g of polyvinylpyrrolidone Pt (Pt: 4 wt %) is added thereto while being stirred. A dried powder is obtained by decompressing and drying the mixture.

A dried powder of the precious metallic clathrate is added into the mixed solution of the cerium oxide-zirconium oxide suspension and the hydration aluminum oxide previously produced, and then stirred again.

After being stirred, a supernatant is thrown away by calming, and then moisture is evaporated by leaving the solution in a thermostat at 150° C. for a day. The catalytic powder is obtained by plasticizing tile dried powder at 400° C. for one hour.

Following is a brief description of the manufacture of the catalyst. Catalytic slurry is obtained by adding 50 g of each catalytic powder in Embodiments 1 to 12 and Comparative Examples 1 to 26 obtained from the above processes, 5 g of boehmite and 157 g of 10% nitric acid-containing aqueous solution into an alumina magnetic pot, and then shaking and crashing it with an alumina ball.

Further, the catalysts in Embodiments 1 to 12 and Comparative Examples 1 to 26 are obtained by removing surplus slurry in the air current by adding such a catalytic slurry into 0.0595 L of a cordierite honeycomb substrate (400 cell/4 mils), and then drying it at 120° C. and coating a catalytic powder to the honeycomb substrate by plasticizing again in the air current at 400° C.

The catalyst obtained by such a sample production is evaluated by the following methods.

First described in the catalyst durability test. For a V-type six cylinder engine by Nissan Motor Co., Ltd., a catalyst durability test is performed for 30 hours by setting a temperature at a catalyst entrance as 1000° C. Further, lead-free gasoline is used as a fuel.

A catalyst evaluation test is performed by cutting off a part of the catalyst bearing body, wherein the durability test was performed and setting a catalyst capacity as 40 ml. The test is performed under the conditions that a flow rate of a reaction gas is 40 L/min, a temperature of the reaction gas is raised from 200° C. to 500° C. by 10° C./min, and a composition of the reaction gas is as shown in Table 1 below. Further, the flow rate of the reaction gas is 40 L/min. A composition of an outlet gas is measured by a continuous analyzer and an exhaust gas inversion rate at each temperature is calculated from the obtained inlet and outlet gas concentrations. A temperature wherein an outlet gas concentration becomes a half of an inlet gas concentration, that is the inversion rate becomes 50%, is indicated as T50. A catalyst performance is evaluated by allowing a temperature of a 50% inversion rate of HC to be HC-T50.

TABLE 1

| | | | | | HC | | |
|---|---|---|---|---|---|---|---|
| NO | CO | H₂ | O₂ | CO₂ | ppm | H₂O | |
| (ppm) | (%) | (%) | (%) | (%) | C | (%) | N₂ |
| 1000 | 0.6 | 0.2 | 0.6 | 13.9 | 1665 | 10 | remaining |
| | | | | | | | portion |

Next described in the catalyst purification performance. Table 2 shows a 50% purifying temperature of HC (HC-T50) of Embodiments 1 to 12 and Comparative Examples 1 to 26.

As can be understood from Table 2, since sintering of the promoter is restrained in Embodiments 1 to 12, the HC-T5 decreases, thereby improving the catalyst activity.

Since there is no promoter in Comparative Example 1, the HC-T50 is higher and the activity is lower than those of the Embodiments. Since the promoter is sintered by high temperature engine durability in Comparative Examples 2 to 7, the HC-T50 is higher and the activity is lower than those of the Embodiments.

From the above, it can be seen that deterioration of the promoter performance is restrained in the catalyst in accordance with the embodiments taught herein wherein the promoter is covered with the high heat-resistant oxide.

The above-described embodiments have been described in order to allow easy understanding of the invention and do not limit the invention. On the contrary, the invention is intended to cover various modifications and equivalent arrangements included with i the scope of the appended claims, which scope is to be accorded the broadest interpretation so as to encompass all such modifications and. equivalent structure as is permitted under the law.

TABLE 2

| Precious metallic component | HC-T50 [° C.] |
|---|---|
| Pt | |
| Embodiment 1 | 388 |
| Embodiment 2 | 391 |
| Embodiment 3 | 402 |
| Embodiment 4 | 391 |
| Embodiment 5 | 375 |
| Embodiment 6 | 370 |
| Pd | |
| Embodiment 7 | 315 |
| Embodiment 8 | 325 |
| Embodiment 9 | 319 |
| Embodiment 10 | 328 |
| Embodiment 11 | 310 |
| Embodiment 12 | 303 |
| Pt | |
| Comparative Example 1 | 486 |
| Comparative Example 2 | 471 |
| Comparative Example 3 | 469 |
| Comparative Example 4 | 472 |
| Comparative Example 5 | 476 |
| Comparative Example 6 | 465 |
| Comparative Example 7 | 459 |
| Pd | |
| Comparative Example 8 | 350 |
| Comparative Example 9 | 341 |
| Comparative Example 10 | 347 |
| Comparative Example 11 | 358 |
| Comparative Example 12 | 355 |
| Comparative Example 13 | 341 |
| Comparative Example 14 | 333 |
| Pt | |
| Comparative Example 15 | 421 |
| Comparative Example 16 | 422 |
| Comparative Example 17 | 431 |
| Comparative Example 18 | 428 |
| Comparative Example 19 | 418 |
| Comparative Example 20 | 399 |
| Comparative Example 21 | 421 |
| Comparative Example 22 | 422 |
| Comparative Example 23 | 431 |
| Comparative Example 24 | 428 |
| Comparative Example 25 | 418 |
| Comparative Example 26 | 399 |

What is claimed is:

1. A catalyst for purification of exhaust gas comprising:
a promoter clathrate having a promoter component particle covered with a high heat-resistant oxide; and
a catalytic active species adjacent to the promoter clathrate, wherein the catalytic active species comprises a first metallic oxide, catalytic active particles born on the first metallic oxide, and a second metallic oxide, and wherein the second metallic oxide operates as a cage around the catalytic active particles and the first metallic oxide.

2. The catalyst for purification of exhaust gas according to claim 1 wherein the promoter component particle is an oxide comprising at least one of Mn, Fe, Ni, Co, Cu and Zn; and wherein the high heat-resistant oxide comprises ZrO₂ and none or more than one species of CeO₂, Y₂O₃, La₂O₃, CaO and Nd₂O₃.

3. The catalyst for purification of exhaust gas according to claim 1 wherein the promoter component particle is an oxide comprising at least one of Ce, La, Nd, Pr, Sm and Dy; and wherein the high heat-resistant oxide comprises Al₂O₃.

4. The catalyst for purification of exhaust gas according to claim 3 wherein the high heat-resistant oxide of the promoter component particle further comprises at least one of CeO₂, Y₂O₃, La₂O₃ and Nd₂O₃.

5. The catalyst for purification of exhaust gas according to claim 4 wherein the promoter component particle is Ce oxide or CeO₂—ZrO₂; and wherein the high heat-resistant oxide is Al₂O₃.

6. The catalyst for purification of exhaust gas according to claim 1 wherein the promoter component particle is at least one oxide of any one of Mn, Fe, Ni and Co; and wherein the high heat-resistant oxide is ZrO₂—Y₂O₃.

7. The catalyst for purification of exhaust gas according to claim 1 wherein the catalytic active particles are composed of at least one precious metal; the precious metal comprising at least one of Pt, Pd, Rh, Au, Ag, Ir and Ru.

8. The catalyst for purification of exhaust gas according to claim 1 wherein the first metallic oxide is at least one of Al₂O₃, CeO₂, ZiO₂, La₂O₃ and Nd₂O₃.

9. The catalyst-for purification of exhaust gas according to claim 1 wherein the second metallic oxide is at least one of Al₂O₃, CeO₂, ZrO₂, Y₂O₃, La₂O₃ and Nd₂O₃.

10. A catalyst for purification of exhaust gas comprising:
a promoter clathrate composed of promoter component particle covered with a high heat-resistant oxide; and
a catalytic active species adjacent to the promoter clathrate, wherein the catalytic active species comprises a composite oxide particle and a metal oxide, wherein the composite oxide particle is composed of at least one precious metal and at least one rare-earth element; and wherein the metal oxide operates as a cage around the composite oxide particle.

11. The catalyst for purification of exhaust gas according to claim 10 wherein the promoter component particle is an oxide comprising at least one of Mn, Fe, Ni, Co, Cu and Zn; and wherein the high heat-resistant oxide comprises ZrO₂ and none or more than one species of CeO₂, Y₂O₃, La₂O₃, CaO and Nd₂O₃.

12. The catalyst for purification of exhaust gas according to claim 10 wherein the promoter component particle is an oxide comprising at least one of Ce, La, Nd, Pr, Sin and Dy; and wherein the high heat-resistant oxide comprises Al₂O₃.

13. The catalyst for purification of exhaust gas according to claim 12 wherein the high heat-resistant oxide further comprises at least one of CeO₂, Y₂O₃, La₂O₃ and Nd₂O₃.

14. The catalyst for purification of exhaust gas according to claim 10 wherein the promoter component particle is at least one of Mn, Fe, Ni and Co oxides; and wherein the high heat-resistant oxide is ZrO₂—Y₂O₃.

15. The catalyst for purification of exhaust gas according to claim 10 wherein the promoter component particle is Ce oxide or CeO₂—ZrO₂; and wherein the high heat-resistant oxide is Al₂O₃.

16. The catalyst for purification of exhaust gas according to claim 10 wherein the precious metal is at least one of Pt, Pd, Rh, Au, Ag, Ir and Ru.

17. The catalyst for purification of exhaust gas according to claim 10 wherein the rare-earth element is at least one of La, Ce, Pr, Nd and Sm.

18. The catalyst for purification of exhaust gas according to claim 10 wherein the metal oxide located around the composite oxide is at least one of Al₂O₃, CeO₂, ZrO₂, Y₂O₃, La₂O₃ and Nd₂O₃.
